(19) United States
(12) Patent Application Publication
(10) Pub. No.: US 2008/0005261 A1
(43) Pub. Date: Jan. 3, 2008

(54) Grouping Application Protocol Data Units for Wireless Communication

(75) Inventors: Neil Adams, Waterloo (CA); Herbert Little, Waterloo (CA); Dinah Davis, Waterloo (CA)

Correspondence Address: INTEGRAL INTELLECTUAL PROPERTY INC., 1370 DON MILLS ROAD, SUITE 300, TORONTO, ON, M3B 3N7, US

(73) Assignee: Research In Motion Limited, Waterloo (CA)

(21) Appl. No.: 11/420,139

(22) Filed: May 24, 2006

(51) Int. Cl. G06F 15/16

(52) U.S. Cl. 709/217

(57) ABSTRACT

A system comprises a wireless-enabled device that communicates with a wireless-enabled smart card reader to obtain information from or perform operations using a smart card. Commands to access information from a smart card may be sent from the device to the smart card reader, and responses from the smart card may be sent from the smart card reader back to the second device. Communication between the device and the smart card reader via a wireless communication link is slower than communication via a direct link. Communication of two or more commands and/or responses via the wireless communication link may be made more efficient by grouping the commands or responses together in groups.

### COPYRIGHT NOTICE

A portion of the disclosure of this patent document contains material which is subject to copyright protection. The copyright owner has no objection to the facsimile reproduction by any one of the patent document or patent disclosure, as it appears in the Patent and Trademark Office patent file or records, but otherwise reserves all copyright rights whatsoever.

### BACKGROUND

It is common for two or more devices to communicate with each other on a routine basis. For example, a smart card, a smart card reader, and a computing device may communicate with each other on a routine basis in order to transfer information generated by or stored on the smart card to the computing device. On each occasion, the computing device communicates a series of instructions to the smart card reader, which the smart card reader then communicates to the smart card. The smart card reader waits for the smart card's response to each instruction, and then communicates these responses back to the computing device. In part 4 of the International Standards Organization (ISO) 7816 standard for integrated-circuit cards (commonly known as smart cards), each of these individual instructions and responses is called a “command APDU” (Application Protocol Data Units) or a “response APDU” respectively.

If sent over a direct or wired connection, these commands and responses may be transmitted very efficiently. The smart card reader and smart card are able to communicate when in direct physical contact with each other—the smart card has contacts and the smart card reader has a connector. Depending on the design and implementation, the smart card reader and the computing device are able to communicate via a serial port, parallel port, universal serial bus (USB) port, or other direct or wired link.

Wireless communication links are much slower than wired or direct communication links. Yet wireless devices and wireless communications are increasingly replacing wired or direct communication links to allow more flexibility in device design and use. For example, Bluetooth® wireless technology provides an easy way for a wide range of Bluetooth® devices (BT devices) to communicate with each other and connect to the Internet without the need for wires, cables and connectors. Other wireless communication protocols include ZigBee™, radio frequency identification (RFID), ultra wideband (UWB), wireless universal serial bus (USB), IEEE 802.11 and various proprietary wireless communication protocols.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic diagram of an exemplary system involving a smart card reader, according to some embodiments of the invention;

FIG. 2 is a signaling diagram showing an exemplary communication flow of command and response APDUs between the mobile device, smart card reader and smart card, according to some embodiments of the invention;

FIG. 3 is a schematic diagram showing an exemplary data structure format used for grouping the command and response APDUs;

FIG. 4 is a flowchart of an exemplary method for grouping command APDUs and transmitting them to a smart card reader, according to some embodiments of the invention;

FIG. 5 is a flowchart of an exemplary method to be implemented by a smart card reader in communication with another device, according to some embodiments of the invention; and

FIG. 6 is a block diagram of an exemplary system involving a smart card reader, according to some embodiments of the invention;

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

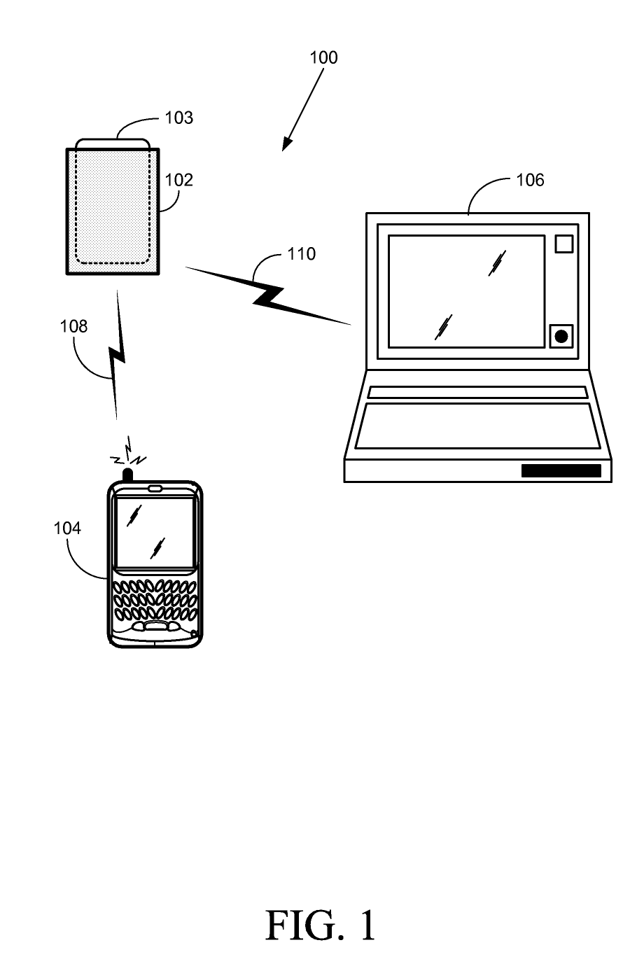

FIG. 1 is a schematic diagram of an exemplary system including a smart card reader, according to some embodiments of the invention. A system 100 includes a wireless-enabled smart card reader (SCR) 102, a wireless-enabled mobile device 104, and a wireless-enabled personal computer 106. A smart card (SC) 103 is shown inserted into smart card reader 102.

Smart card reader 102 and mobile device 104 may communicate via a wireless communication link 108, and smart card reader 102 and personal computer 106 may communicate via a wireless communication link 1 10. In this description and the claims, a wireless communication link may include one or more wired portions and/or one or more optical portions. As shown in FIG. 1, communication links 108 and 110 are wireless communication links, for example Bluetooth® communication links, ZigBee™ communication links, radio frequency identification (RFID) communication links, ultra wideband (UWB) communication links, wireless USB links, IEEE 802.11 communication links and any other suitable type of wireless communication link.

Smart cards are personalized security devices, defined by the ISO 7816 standard and its derivatives, as published by the International Standards Organization. A smart card may have a form factor of a credit card and may include a semiconductor device. The semiconductor device may include a memory that can be programmed with security information (e.g. a private decryption key, a private signing key, biometrics, an authentication certificate, etc.), and may include a decryption engine, e.g. a processor and/or dedicated logic, for example, dedicated decryption logic and/or dedicated signing logic. A smart card may include a connector for powering the semiconductor device and performing serial communication with an external device. Alternatively, smart card functionality may be embedded in a device having a different form factor and different communication protocol, for example a Universal Serial Bus (USB) device. A smart card may be used for visual identification, time cards, door access, and the like.

The person whose security information is stored on smart card 103 may use smart card reader 102, for example, to provide personal identification from smart card 103 to mobile device 104, or to digitally sign and/or decrypt e-mail messages sent by mobile device 104. To accomplish any of these tasks, smart card reader 102 may communicate with smart card 103 using one or more command APDUs. These command APDUs are instructions to smart card 103 that allow smart card reader 102 to obtain the required information from smart card 103. Smart card 103 communicates information back to smart card reader 102 using response APDUs.

For example, when smart card reader 102 extracts personal identification from smart card 103, the following sequence of command and response APDUs are communicated: (i) Smart card reader 102 sends a SELECT FILE A command to smart card 103 to select File A. (ii) Smart card 103 sends a response to smart card reader 102 to confirm that File A was selected. (iii) Smart card reader 102 sends a READ BINARY command to smart card 103 to read the data from File A. (iv) Smart card 103 sends the data to smart card reader 102. (v) Smart card reader 102 sends a SELECT FILE B command to smart card 103 to select File B. (vi) Smart card 103 sends a response to smart card reader 102 to confirm that File B was selected. (vii) Smart card reader 102 sends a READ BINARY command to smart card 103 to read the card label from File B. (viii) Smart card 103 sends the card label from File B to smart card reader 102. These command and response APDUs are communicated serially between smart card reader 102 and smart card 103. This serial communication is efficient because smart card reader 102 and smart card 103 are in direct contact with each other.

In some situations, a request to extract personal information from smart card 103 may originate at mobile device 104. In this case, the command APDUs originate at mobile device 104 and are forwarded by smart card reader 102 to smart card 103, and the response APDUs from smart card 103 are forwarded by smart card reader 102 to mobile device 104. Wireless communication link 108 may be used to communicate the command APDUs from mobile device 104 to smart card reader 102, and to communicate the response APDUs from smart card reader 102 to mobile device 104.

In some embodiments of the invention, mobile device 104 groups at least two command APDUs together into a “command APDU group” for transmission to smart card reader 102, and/or smart card reader 102 groups at least two response APDUs together into a “response APDU group” for transmission to mobile device 104. For example, instead of transmitting individual APDUs as individual Bluetooth® packets, an APDU group comprising two or more APDUs may be transmitted as a single Bluetooth® packet. Typically, the length of an individual APDU is much shorter than the maximum length of a Bluetooth® communication packet; therefore, transmitting a group of APDUs as a single Bluetooth® communication packet takes roughly the same amount of time as transmitting a single APDU as a single Bluetooth® communication packet. By grouping the individual APDUs into a single packet, the number of transmitted Bluetooth® communication packets can be decreased, and the total length of time to transmit the entire set of messages is therefore also decreased.

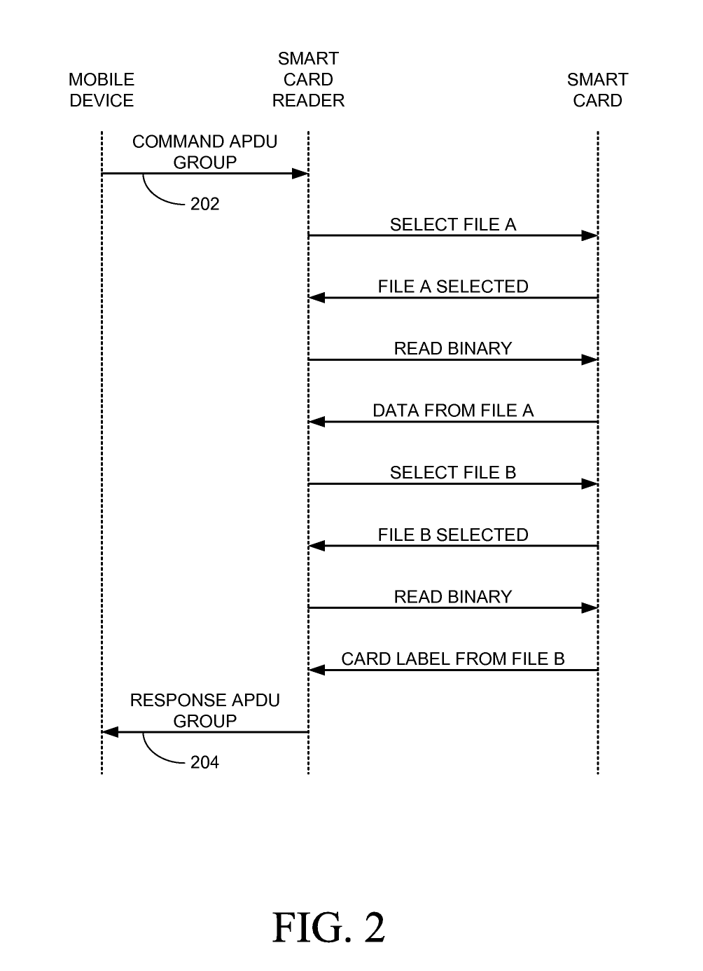

In the aforementioned example, the individual APDUs may be grouped as shown in the signaling diagram of FIG. 2. The signaling sequence shown is as follows: (i) Mobile device 104 sends a command APDU group 202 to smart card reader 102 consisting of: SELECT FILE A, READ BINARY (to read data from File A), SELECT FILE B, READ BINARY (to read label from File B). (ii) Smart card reader 102 communicates the individual command APDUs one at a time to smart card 103, waiting after each command APDU for a corresponding response APDU from smart card 103 before sending the next command APDU. (iii) Smart card reader 102 sends a response APDU group 204 to mobile device 104 consisting of: FILE A SELECTED, data from File A, FILE B SELECTED, label from File B. In this example, the total number of Bluetooth® communications packets sent between mobile device 104 and smart card reader 102 is reduced from eight to two, reducing the total time for communicating the Bluetooth® packets by roughly a factor of four.

In the aforementioned example, personal computer 106 could take the place of mobile device 104. For example, the person whose security information is stored on smart card 103 may wish to digitally sign outgoing e-mail sent from personal computer 106 or to decrypt incoming encrypted e-mail received at personal computer 106. This would require personal computer 106 to communicate with smart card reader 102 in the same way as mobile device 104 communicates with smart card reader 102 as described above.

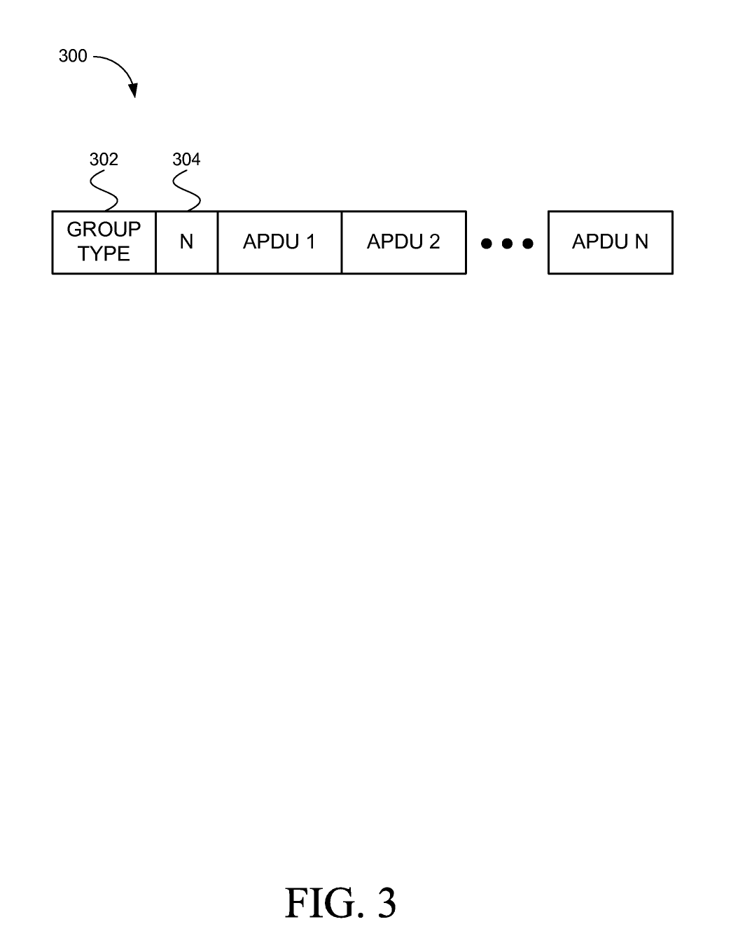

In order to group together the command and response APDUs, smart card reader 102 and mobile device 104 (or personal computer 106) must use a shared APDU group data structure, and the smart card reader and mobile device must be capable of grouping and/or ungrouping messages according to the shared data structure. FIG. 3 shows an example data structure for an APDU group 300. A first byte 302 of the data structure contains information about the group type, e.g. “Command APDU group”, or “Response APDU group”. A second byte 304 gives information about the number N of individual APDUs that are contained in the group. The rest of the data structure contains the individual APDUs, each of which also contains its own individual header and data.

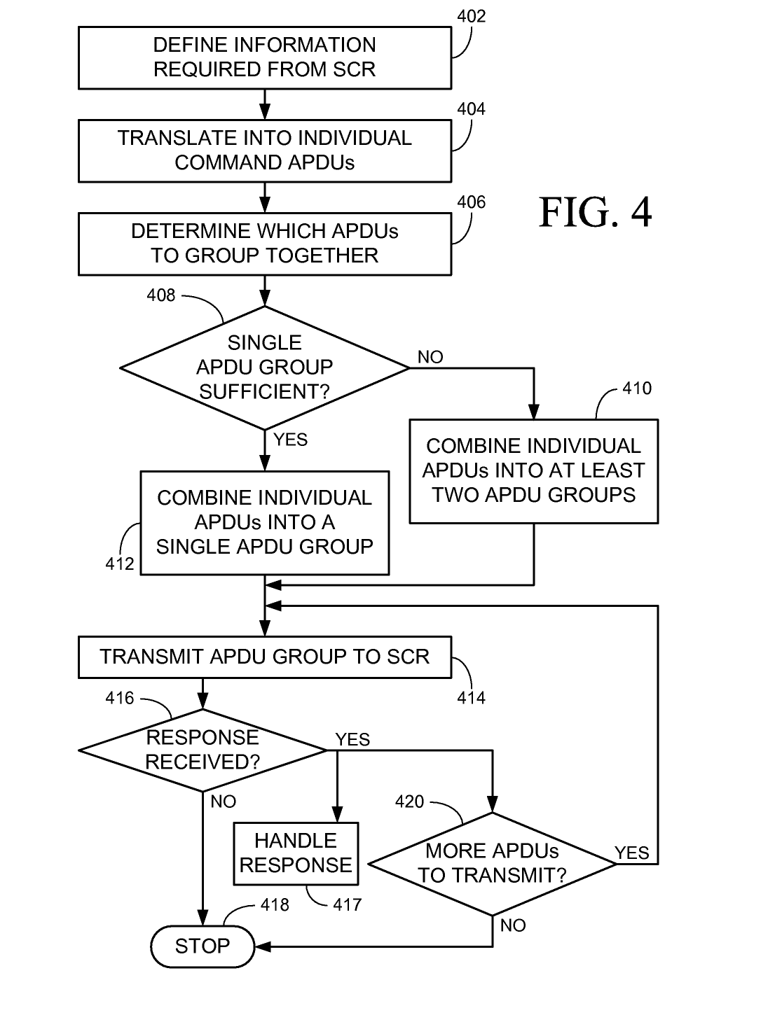

FIG. 4 is a flowchart of an exemplary method for grouping command APDUs and transmitting them to a smart card reader, according to some embodiments of the invention. The method may be implemented by any device that communicates with the smart card reader, for example, mobile device 104 and personal computer 106. The device first determines what information is required from smart card reader 102 (402). The device translates this information requirement into an appropriate series of individual command APDUs for communicating with smart card reader 102 (404). The device determines which APDUs can be grouped together by considering which APDUs can be sent without waiting for a response from smart card reader 102 (406).

The device checks whether all the required individual command APDUs can be sent in a single APDU group (408). If a single command APDU group is sufficient, the device combines the individual APDUs into a single command APDU group (412), transmits this APDU group to smart card reader 102 (414), and waits for a response from smart card reader 102 (416). If no response is received, the process stops (418). Otherwise, the device handles the response (417). If the response is an APDU group, handling the response involves separating the APDU group into individual response APDUs.

If at least two APDU groups are required, the device combines the individual APDUs into the appropriate number of APDU groups (410), transmits the first APDU group to smart card reader 102 (414), and waits for a response from smart card reader 102 (416). The device checks whether there are more APDU groups to transmit (420). If all APDU groups have been sent, the process stops (418). If there remain more APDU groups to send, the device sends the next APDU group and the process 414-420 repeats until all APDU groups are sent and responses are received.

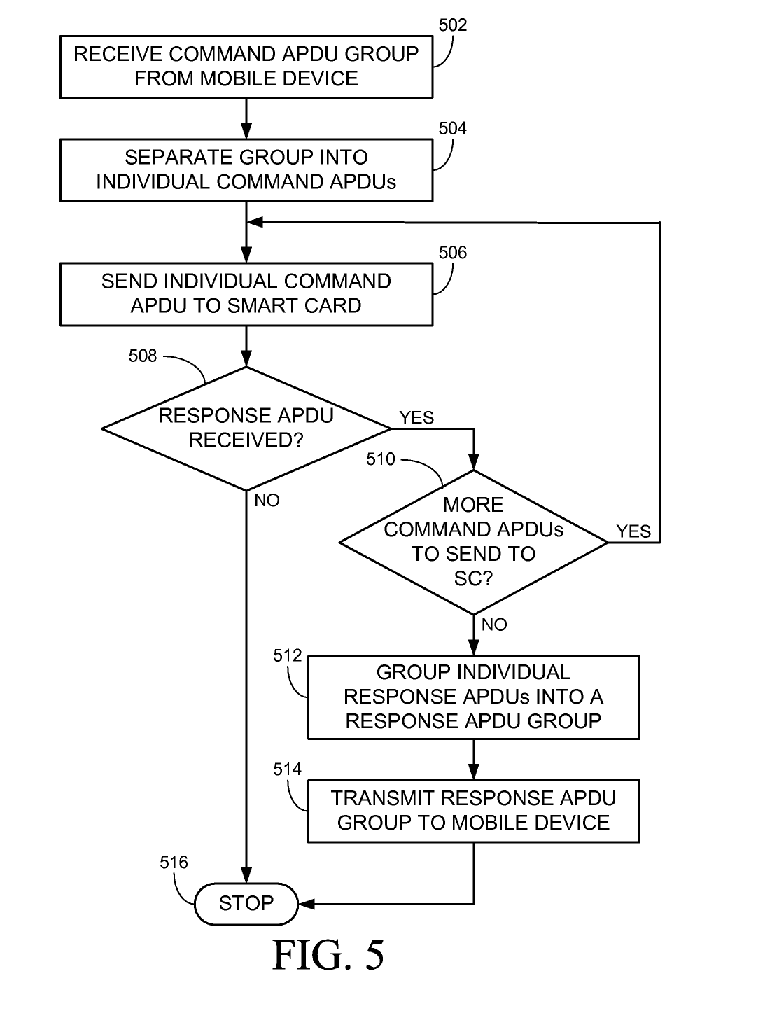

FIG. 5 is a flowchart of an exemplary method for ungrouping command APDUs and grouping response APDUs, according to some embodiments of the invention. Smart card reader 102 receives a command APDU group from a device, which may be, for example, mobile device 104 or personal computer 106 (502). Smart card reader 102 separates the APDU group into individual command APDUs (504). Smart card reader 102 transmits an individual command APDU to smart card 103 (506), and waits for a response from smart card 103 (508). If no response is received, the method stops (516).

If smart card reader 102 receives a response APDU from smart card 103, smart card reader 102 checks whether there remain more command APDUs to send (510). If there do remain more command APDUs, smart card reader 102 sends the next command APDU to smart card 103 (506), and waits for a response (508). Smart card reader 102 continues sending/receiving command and response APDUs until all command APDUs have been sent and all response APDUs have been received from smart card. Smart card reader 102 groups together the individual response APDUs from smart card 103 into a single response APDU group (512), which it then transmits to the device (514). This entire process is repeated for each command APDU group that is received by smart card reader 102 from the device.

The following exemplary code sample demonstrates how individual command APDUs may be grouped together, transmitted as a single command APDU group, and how a single response APDU group may be received and parsed into individual response APDUs.

```
protected SmartCardID getSmartCardID( ) throws SmartCardException
{
  // Select the DKIS File which contains the serial number
  CommandAPDU selectDKISFileAPDU = getSelectFileCommand(new byte[ ] {0x00, 0x06});
  // The serial number is in the first 8 bytes of this file
  CommandAPDU readDKISBinaryAPDU = new CommandAPDU(CLASS_00,
INS_READ_BINARY, ZERO_BYTE, ZERO_BYTE, 8);
  // Select UIS File which contains the card label in the first 32 bytes
  CommandAPDU selectUISFileAPDU = getSelectFileCommand(new byte[ ] {0x00, 0x0A});
  // The card label is in the first 32 bytes of this file
  CommandAPDU readUISBinaryAPDU = new CommandAPDU(CLASS_00,
INS_READ_BINARY, ZERO_BYTE, ZERO_BYTE, 32);
  CommandAPDUGroup commandAPDUGroup = new CommandAPDUGroup(
    new CommandAPDU [ ] {selectDKISFileAPDU, readDKISBinaryAPDU, selectUISFileAPDU,
readUISBinaryAPDU});
  ResponseAPDUGroup responseAPDUGroup = new ResponseAPDUGroup(4);
  sendAPDUs(commandAPDUGroup, responseAPDUGroup);
  // Check the response from the read DKIS Binary file
  if(!responseAPDUGroup.getAPDU(1).checkStatusWords((byte)0x90, (byte)0x00))}
      return null;
  }
  byte [ ] serialNumber = new byte[8];
  System.arraycopy(responseAPDUGroup.getAPDU(1).getData( ), 0, serialNumber, 0, 8);
  // Convert byte array to long
  long idLong = CryptoByteArrayArithmetic.valueOf(serialNumber);
  // Check the response from the read UIS Binary file
  if(!responseAPDUGroup.getAPDU(3).checkStatusWords((byte)0x90, (byte)0x00))}
      return null;
  }
  String cardLabel = new String(responseAPDUGroup.getAPDU(3).getData( ), 0, 32);
  // Trim the spaces off the end. This is a fixed length field of
  // length 32 so it will likely have spaces at the end.
  cardLabel = cardLabel.trim( );
  return new SmartCardID(idLong, cardLabel, getSmartCard( ));
}
```

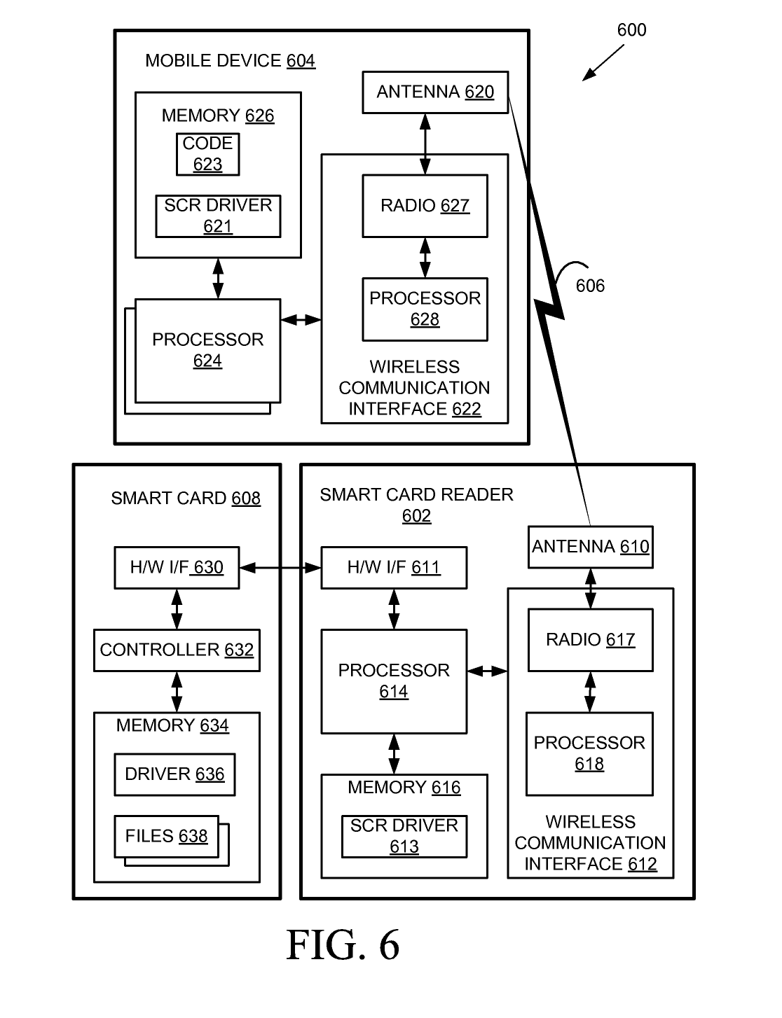

FIG. 6 is a block diagram of an exemplary system 600, according to some embodiments of the invention. System 600 comprises a device 604 and a smart card reader 602 able to communicate over a wireless communication link 606, and a smart card 608 in direct communication with smart card reader 602.

A non-exhaustive list of examples for device 604 includes any of the following:

a) wireless human interface devices, for example, keyboards, mice, remote controllers, digital pens and the like;

b) wireless audio devices, for example, headsets, loudspeakers, microphones, cordless telephones, handsets, stereo headsets and the like;

c) wireless computerized devices, for example, notebook computers, laptop computers, desktop personal computers, personal digital assistants (PDAs), handheld computers, cellular telephones, MP3 players, printers, facsimile machines, and the like; and

d) wireless communication adapters, for example, universal serial bus (USB) adapters, personal computer memory card international association (PCMCIA) cards, compact flash (CF) cards, mini peripheral component interconnect (PCI) cards, access points, and the like.

Device 604 comprises an antenna 620, a wireless communication interface 622, a processor 624 coupled to wireless communication interface 622, and a memory 626 coupled to processor 624. Memory 626 may be fixed in or removable from device 604. Memory 626 may be embedded or partially embedded in processor 624. Memory 626 stores executable code 621 which, when executed by processor 624, functions as a smart card reader driver. Memory 626 also stores executable code 623 which, when executed by processor 624 functions to run an application program. Processor 624 and memory 626 may be part of the same integrated circuit or in separate integrated circuits. Wireless communication interface 622 comprises a radio 627 coupled to antenna 620, and a processor 628 coupled to radio 627. Wireless communication interface 622 and processor 624 may be part of the same integrated circuit or in separate integrated circuits.

Similarly, smart card reader 602 comprises an antenna 610, a wireless communication interface 612, a processor 614 coupled to wireless communication interface 612, a hardware interface 611, and a memory 616 coupled to processor 614. For example, hardware interface 611 is a connector. Memory 616 may be fixed in or removable from device 602. Memory 616 may be embedded or partially embedded in processor 614. Memory 616 stores executable code 613 that functions as a smart card reader driver when executed by processor 614. Processor 614 and memory 616 may be part of the same integrated circuit or in separate integrated circuits. Wireless communication interface 612 comprises a radio 617 coupled to antenna 610, and a processor 618 coupled to radio 617. Wireless communication interface 612 and processor 614 may be part of the same integrated circuit or in separate integrated circuits.

A non-exhaustive list of examples for antennae 610 and 620 includes dipole antennae, monopole antennae, multilayer ceramic antennae, planar inverted-F antennae, loop antennae, shot antennae, dual antennae, omnidirectional antennae and any other suitable antennae.

A non-exhaustive list of examples of communication protocols with which communication interfaces 612 and 622 may be compatible includes Bluetooth®, ZigBee™, radio frequency identification (RFID), ultra wideband (UWB), IEEE 802.11, and proprietary communication protocols.

A non-exhaustive list of examples for processors 614, 618, 624 and 628 includes a central processing unit (CPU), a digital signal processor (DSP), a reduced instruction set computer (RISC), a complex instruction set computer (CISC) and the like. Furthermore, processors 614, 618, 624 and 628 may be part of application specific integrated circuits (ASICs) or may be a part of application specific standard products (ASSPs).

A non-exhaustive list of examples for memories 616 and 626 includes any combination of the following:

a) semiconductor devices such as registers, latches, read only memory (ROM), mask ROM, electrically erasable programmable read only memory devices (EEPROM), flash memory devices, non-volatile random access memory devices (NVRAM), synchronous dynamic random access memory (SDRAM) devices, RAMBUS dynamic random access memory (RDRAM) devices, double data rate (DDR) memory devices, static random access memory (SRAM), universal serial bus (USB) removable memory, and the like;

b) optical devices, such as compact disk read only memory (CD ROM), and the like; and

c) magnetic devices, such as a hard disk, a floppy disk, a magnetic tape, and the like.

Smart card 608 comprises a hardware interface 630, a controller 632 coupled to hardware interface 630, and a memory 634 coupled to controller 632. For example, hardware interface 630 comprises contacts. Memory 634 stores executable code 636 which functions as a driver when executed by controller 632. Memory 634 also stores files 638 with stored personal information about the smart card's owner.

Device 604, smart card reader 602 and smart card 608 comprise additional components which are not shown in FIG. 6 and which, for clarity, are not described herein.

As mentioned above, memory 626 may store executable code 623 which, when executed by processor 624, runs an application program. This application may require information from smart card 608 to successfully perform a function. The application code may determine what information is required from smart card 608, and may send a request for this information to smart card reader driver 621. Smart card reader driver 621 may then translate this request for information into a series of individual command APDUs. Smart card reader driver 621 may then group together two or more command APDUs forming an APDU group which may then be communicated to smart card reader 602 through the wireless communication interface 622.

Smart card reader 602 may receive the APDU group from device 604 through wireless communication interface 612. Smart card reader driver 613 may, when executed by processor 614, separate the command APDU group into individual command APDUs. Smart card reader driver 613, may then communicate an individual command APDU to smart card 608 through hardware interface 611.

Smart card 608 may receive the individual command APDU through hardware interface 630. Controller 632 may execute the individual command APDU by running executable code 636, and by accessing files 638. Controller 632 may then send an individual response APDU to smart card reader 602 through hardware interface 630.

Processor 614 may receive the individual response APDU through hardware interface 611. SCR driver 613 may then communicate the next individual command APDU to smart card 608 and wait for a response APDU from smart card 608 before sending the next command APDU. When all command APDUs have been sent and all response APDUs received, SCR driver 613 may group the response APDUs into a single response APDU group. Smart card reader 602 may then send the response APDU group to device 604 via wireless communication interface 612.

Device 604 may receive the response APDU group from smart card reader 602 via wireless communication interface 622. SCR driver 621 may separate the response APDU group into individual response APDUs for processing. SCR driver 621 may then process the individual response APDUs for use by the application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for communicating Application Protocol Data Units (APDUs) by a first wireless-enabled device, the method comprising:
combining at least two individual APDUs in a single APDU group; and
transmitting the APDU group using a wireless communication link to a second wireless-enabled device.

2. The method of claim 1, further comprising:
receiving another APDU group over the wireless communication link from the second wireless-enabled device; and
separating the other APDU group into individual APDUs.

3. The method of claim 1, wherein the first device includes smart card reader functionality.

4. The method of claim 1, wherein the second device includes smart card reader functionality.

5. The method of claim 1, wherein the individual APDUs are command APDUs.

6. The method of claim 5, further comprising:
determining that none of the command APDUs depend on a response to another of the command APDUs.

7. The method of claim 1, wherein the individual APDUs are response APDUs.

8. A device comprising:
a wireless communication interface;
a processor coupled to the wireless communication interface; and
a memory coupled to the processor, the memory able to store code which, when executed by the processor, groups at least two individual Application Protocol Data Units (APDUs) into an APDU group in preparation for transmission via the wireless communication interface.

9. The device of claim 8, wherein the device contains smart card reader functionality.

10. The device of claim 8, wherein the individual APDUs are command APDUs.

11. The device of claim 8, wherein the individual APDUs are response APDUs.

12. The device of claim 8, wherein the wireless communication interface is compatible with Bluetooth®communication protocols.

13. The device of claim 8, wherein the wireless communication interface is compatible with ultra wideband (UWB) communication protocols.

14. The device of claim 8, wherein the wireless communication interface is compatible with ZigBee™ communication protocols.

15. The device of claim 8, wherein the wireless communication interface is compatible with radio frequency identification (RFID) communication protocols.

16. The device of claim 8, wherein the wireless communication interface is compatible with wireless universal serial bus (USB) communication protocols.

17. The device of claim 8, wherein the wireless communication interface is compatible with one or more IEEE 802.11 communication protocols.

18. A system for communicating messages comprising:
a first wireless-enabled device compatible with at least one wireless communication protocol; and
a second wireless-enabled device comprising:
a wireless communication interface compatible with at least the wireless communication protocol;
a processor coupled to the wireless communication interface; and
a memory coupled to the processor, the memory able to store code which, when executed by the processor, groups two or more individual Application Protocol Data Units (APDUs) into an APDU group, and transmits the APDU group to the first device via the wireless communication interface.

19. The system of claim 18, wherein the APDU group is received by the first wireless-enabled device which is able to separate the APDU group into individual APDUs.

20. The system of claim 18, wherein the first device includes smart card reader functionality.

21. The system of claim 18, wherein the second device includes smart card reader functionality.

22. The system of claim 18, wherein the individual APDUs are command APDUs.

23. The system of claim 18, wherein the individual APDUs are response APDUs.
